(19) United States
(12) Patent Application Publication
(10) Pub. No.: US 2009/0199840 A1
(43) Pub. Date: Aug. 13, 2009

(54) Barbeque grill ignition apparatus

(76) Inventor: Kao-Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/068,780

(22) Filed: Feb. 12, 2008

(51) Int. Cl. A47J 37/07

(52) U.S. Cl. 126/25 B; 431/253

(57) ABSTRACT

A barbeque grill ignition apparatus installed between a stove with a gas inlet pipe and a pressure reducing valve connected to a gas fuel includes a gas valve with a fuel gas channel and a spitfire pipe. A gas inlet of the fuel gas channel is connected to the pressure reducing valve. A gas outlet is connected to a gas inlet pipe of the stove. An end of the spitfire pipe is interconnected with the fuel gas channel, and another end is a fire vent. The height of the spitfire pipe is equal to or slightly greater than the height of the stove. The gas fuel passed into the stove is burned after the igniter is started. The flame is ejected from a fire vent to the stove to ignite the gas fuel. A quick and convenient ignition can be achieved without making any change to the stove.

### BACKGROUND OF THE INVENTION

1. Field of the Invention

The present invention relates to a barbeque grill ignition technology, and more particularly to a convenient ignition apparatus of a portable barbeque grill oven.

2. Description of the Related Art

As barbeque food becomes increasingly popular, people love to have barbeques, and they generally use a portable barbeque grill for the barbeque activities conducted indoors or outdoors. Some barbeque grills also come with an infrared stove, and thus saving fuel and providing a sanitary, convenient and good cooking effect, and thus most portable grills are equipped with an infrared stove.

In FIG. 1, a common stove 1 available in the market generally adopts an electrode ignition apparatus 2 for an ignition, and the electrode ignition apparatus 2 is usually installed on the stove 1, but such arrangement not only gives a low ignition percentage, but also requires a close attachment of the electrode ignition apparatus with a stove plate. Therefore, it is necessary to design a dent 3 on a protecting net of the stove 1 and install an ignition pipe on the dent 3 of a protecting net of the stove 1 to assure a successful ignition. The structure of the stove according to the aforementioned ignition method not only gives a low ignition percentage, but also creates an opening on the protecting net of the stove which will affect the burning effect and the aesthetic appearance.

In general, the portable barbeque grills of this sort adopts a turning steel bottle for the fuel supply, and the steel bottle is turned to engage with barbeque grill when needed. In the meantime, a device for adjusting the fire of the portable barbeque grill is usually installed on a pressure reducing valve, and the pressure reducing valve is turned according to the adjusting direction and position to facilitate the adjustment, and screws are installed at a gas outlet at the front of a gas outlet pipe and secured into corresponding screw holes at a distal surface of the gas inlet hole of the stove, such that the pressure reducing valve can be turned freely by an external force to facilitate the fire adjustment. When the barbeque grill is placed on a tabletop for the barbeque activity, the height of the bottom of the stove from the tabletop is usually short, since the light and convenient steel bottle is generally bundled with the barbeque grill. As a result, it is necessary to install the steel bottle slantingly.

Although some barbeque manufactures want to apply the spitfire ignition apparatus to the aforementioned stove, yet the spitfire ignition apparatus is integrated with the valve and cannot be turned. Obviously, such design creates an issue for fixing a freely rotated pressure reducing valve to the steel bottle.

### SUMMARY OF THE INVENTION

Therefore, it is a primary objective of the present invention to overcome the foregoing shortcomings of the prior art by providing a spitfire ignition apparatus capable of connecting a stove without making changes to the existing stove.

Another objective of the present invention is to provide a barbeque grill ignition apparatus capable of connecting a pressure reducing valve and a fuel gas bottle quickly, and turning the pressure reducing valve freely.

To achieve the foregoing objectives, the invention provides a barbeque grill ignition apparatus installed between a stove having a gas inlet pipe and a pressure reducing valve connected to a gas fuel. The barbeque grill ignition apparatus comprises: a gas valve including a fuel gas channel therein and a spitfire pipe, wherein a gas inlet of the fuel gas channel is connected to the pressure reducing valve, and a gas outlet is connected to a gas inlet pipe of the stove, and an end of the spitfire pipe is interconnected with the fuel gas channel, and another end of the spitfire pipe is a fire vent, and the height of the spitfire pipe is equal to or slightly greater than the height of the stove. After a gas fuel enters into the fuel gas channel of the gas valve from a pressure reducer, a large portion of the gas fuel is passed into the stove through the gas outlet, and the gas fuel in the spitfire pipe is burned after the igniter is started, and the flame is ejected from a fire vent to the top of the stove to ignite the gas fuel that enters into the stove.

In the present invention, the spitfire pipe is installed on the gas valve, and thus the flame can be guided to the stove without making any change to the stove, particularly designing a dent on the stove for guiding the flame to ignite the gas fuel quickly and conveniently.

The spitfire pipe can be in a right-angled shape and installed at the top of the gas valve. The spitfire pipe can also be in an arc shape or any other shape according to an actual required structure or a personal preference.

To connect the pressure reducing valve with the gas valve quickly and achieve the effect of turning the pressure reducing valve freely, the gas inlet of the fuel gas channel can be connected to the pressure reducing valve through a quick connector. The quick connector provides a quick, safe and convenient way of connecting or separating the gas valve with the pressure reducer, and also allows the pressure reducing valve to be turned freely to any angle.

In the preferred embodiment, a connecting pipe is installed and connected between the gas inlet of the gas valve fuel gas channel and the quick connector, and thus not only facilitating the installation of the product, but also allowing users to turn the pressure reducing valve freely. In the meantime, the fuel gas bottle connected to the pressure reducing valve keeps a specific distance from the gas valve for containing and installing the fuel gas bottle conveniently.

The connecting pipe is connected to a male connector of the quick connector, and a female connector of the quick connector is fixed onto the pressure reducing valve.

The connecting pipe, the gas valve and the male connector can be installed into a control box to provide a safe use and a tidy appearance of the product.

Compared with the prior art, the invention installs a spitfire pipe onto the gas valve for igniting and guiding the flame to the stove, and thus it is not necessary to make any change to the existing stove or particularly require a design of creating a dent on the stove to make the ignition quickly and conveniently.

Further, the ignition apparatus of the invention adopts a spitfire for the ignition, and thus providing a larger range of flames, controlling the ignition time, and giving a high ignition percentage close to 100%. In the meantime, the quick connector installed between the gas valve and the pressure reducing valve not only makes the connection at an instant safely and conveniently, but also solves the problem of the spitfire ignition apparatus that cannot be turned at all. The pressure reducing valve of the invention can be turned freely according to the requirements of the application.

### BRIEF DESCRIPTION OF THE DRAWINGS

FIG. 1 is a perspective view of a common ignition apparatus of a prior art barbeque grill;

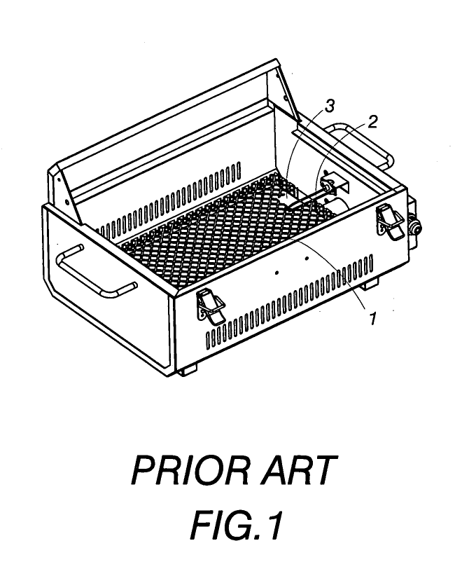

FIG. 2 is a perspective view of a preferred embodiment of the present invention;

FIG. 3 is an exploded view of FIG. 2; and

FIG. 4 is a perspective view of a gas valve a preferred embodiment of the present invention.

### DETAILED DESCRIPTION OF THE PREFERRED EMBODIMENTS

The objective, technical measures and performance of the present invention will become apparent in the detailed description of the preferred embodiments with reference to the accompanying drawings as follows:

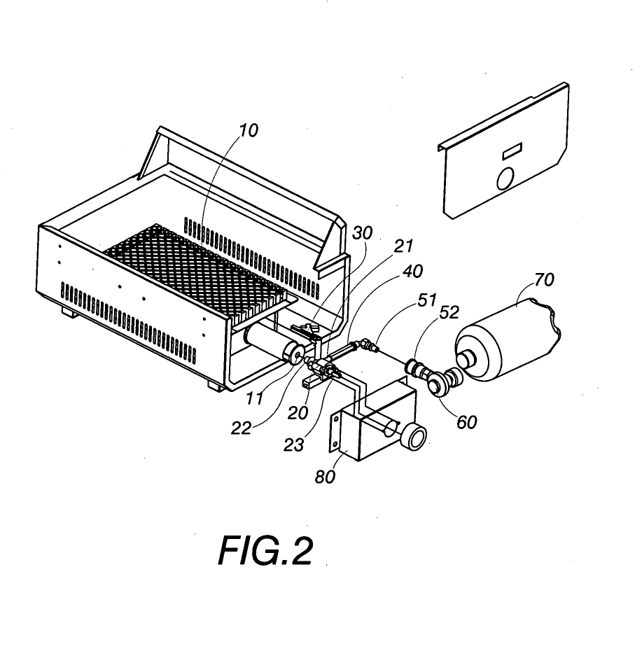

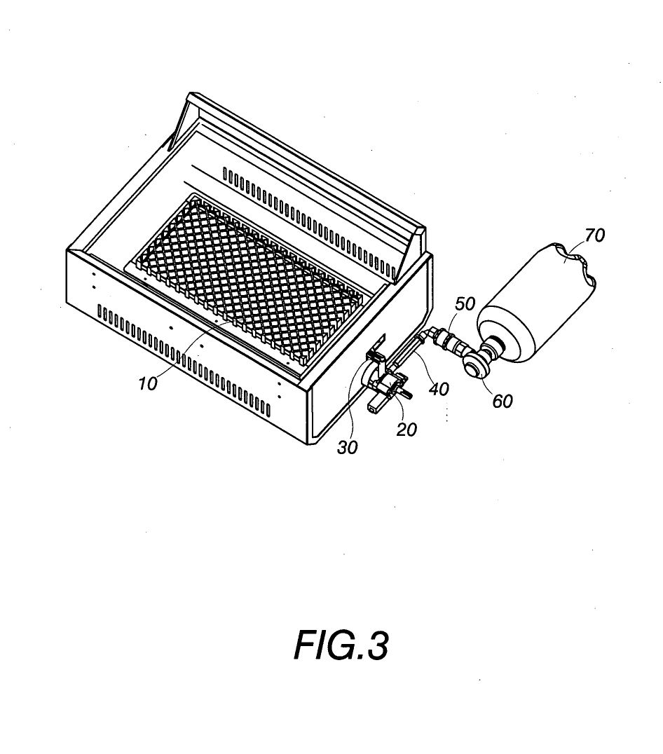

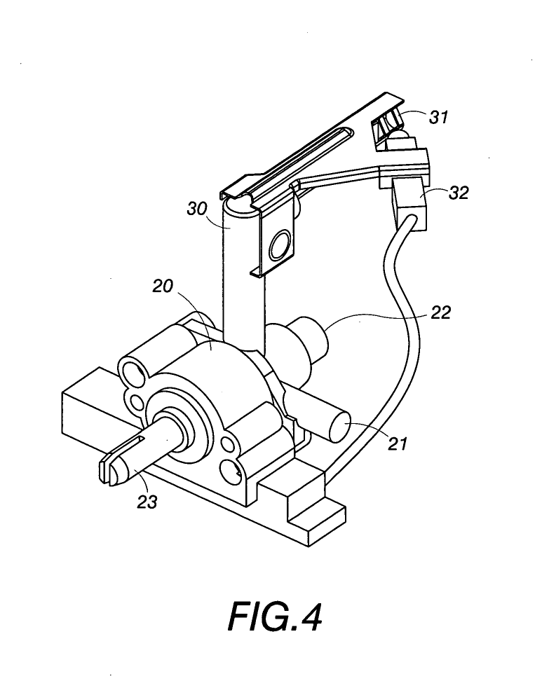

Referring to FIGS. 2 to 4, for a barbeque grill ignition apparatus of the invention, the apparatus is installed between a stove 10 and a pressure reducing valve 60, wherein the stove 10 has a gas inlet pipe 11, and the pressure reducing valve 60 is connected to a fuel gas bottle 70. The barbeque grill ignition apparatus in accordance with a preferred embodiment further comprises a gas valve 20 fixed onto the spitfire pipe 30 connected to the gas valve 20, the connecting pipe 40, and the quick connector 50 connected to the pressure reducing valve 60.

In the figure, the gas valve 20 includes a fuel gas channel (not shown in the figure), a gas inlet 21 installed on a right side of the gas valve 20 for supplying a gas fuel into the fuel gas channel, and a gas outlet 22 connected to the front end of the gas inlet pipe 11 of the stove 10, wherein the rear end of the gas inlet pipe 11 is an axle 23 for adjusting the fire, and a spitfire pipe 30 is fixed onto the top of the gas valve 20, and an end of the spitfire pipe 30 is interconnected to the fuel gas channel, and another end is a fire vent 31 with a height slightly higher than a stove surface of the stove 10. In the figure, the spitfire pipe 30 is a right-angled shape.

The gas outlet 22 of the gas valve 20 is aligned and inserted into the gas inlet pipe 11 of the stove 10, and the gas inlet 21 of the gas valve 20 is connected to an end of the connecting pipe 40, and another end of the connecting pipe 40 is connected to a male connector 51 of the quick connector 50, and a female connector 52 of the quick connector 50 is turned and connected onto an gas outlet hole of the pressure reducing valve 60, such that the pressure reducing valve 60 is connected to a fuel gas bottle 70, and the gas fuel in the fuel gas bottle 70 is passed sequentially through the pressure reducing valve 60, the quick connector 50, the connecting pipe 40 and the spitfire pipe 30 and the gas outlet 22 of the gas valve 20 is connected to the stove 10.

To provide a convenient installation, a tidy appearance, and an easy carry of the product, the gas valve 20, the connecting pipe 40 and the male connector 51 of this embodiment are installed in a control box 80, wherein the male connector 51 is exposed from the control box 80 to facilitate the connection with the female connector 52.

During use, the female connector 52 of the quick connector 50 is engaged with the male connector 51, and then the gas fuel is turned on, and the gas fuel enters into the fuel gas channel through the pressure reducing valve 60, the quick connector 50 and the connecting pipe 40, such that a small portion of gas fuel in the fuel gas channel is entered into the spitfire pipe 30, and a large portion of gas fuel is entered into the gas inlet pipe 11 of the stove 10. Now, an igniter 32 is used for igniting the gas fuel coming out from the spitfire pipe 30, and the flame is ejected from the fire vent 31 to the stove 10 to ignite the gas fuel coming out from the stove 10 for a normal operation of the barbeque grill. If it is necessary to adjust the fire, the axle 23 is turned to an appropriate position.

While the invention has been described by means of specific embodiments, numerous modifications and variations could be made by those skilled in the art without departing from the scope and spirit of the invention set forth in the claims.

1. A barbeque grill ignition apparatus, installed between a stove with a gas inlet pipe and a pressure reducing valve connected to a gas fuel, comprising:
a gas valve with a fuel gas channel disposed therein and a spitfire pipe, wherein a gas inlet of the fuel gas channel is connected to the pressure reducing valve, a gas outlet of the fuel gas channel is connected to a gas inlet pipe of the stove, and a first end of the spitfire pipe is interconnected to the fuel gas channel and a second end of the spitfire pipe is a fire vent having a height equal to or slightly greater than the height of a stove surface of the stove,
wherein the gas inlet of the fuel gas channel is connected to the pressure reducing valve through a quick connector which is rotatably connected to the pressure reducing valve to permit the pressure reducing valve to be disposed at any angle with respect to the gas inlet, the gas inlet of the fuel gas channel is connected to the quick connector through a connecting pipe, and the quick connector includes a male connector and a female connector, the connecting pipe being connected to the male connector and the female connector being fixed onto the pressure reducing valve.

2. The barbeque grill ignition apparatus of claim 1, wherein the spitfire pipe is in a right-angled shape.

3-5. (canceled)

6. The barbeque grill ignition apparatus of claim 5, wherein the gas valve, the connecting pipe and the male connector are installed in a control box.
